(19) United States
(12) Patent Application Publication
(10) Pub. No.: US 2005/0285528 A1
(43) Pub. Date: Dec. 29, 2005

(54) Plasma display panel

(75) Inventors: Yoichi Okumura, Yamanashi-ken (JP); Masaki Yoshinari, Yamanashi-ken (JP); Takashi Yamada, Yamanashi-ken (JP); Tasuku Ishibashi, Yamanashi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 11/166,147

(22) Filed: Jun. 27, 2005

(30) Foreign Application Priority Data
Jun. 28, 2004 (JP) 2004-189314

(51) Int. Cl. H01J 17/49

(52) U.S. Cl. 313/583

(57) ABSTRACT

Row electrode pairs are formed on the front glass substrate of the PDP. Each of the row electrodes constituting a row electrode pair has a bus electrode and transparent electrodes each connected to the bus electrode and initiating a sustaining discharge in conjunction with the other row electrode paired therewith. The transparent electrodes are formed on the front glass substrate. Bus-electrode separating-off dielectric layers are formed on portions of the back-facing face of the front glass substrate. Each of the bus electrodes is formed on the bus-electrode separating-off dielectric layer.

### BACKGROUND OF THE INVENTION

1. Field of the Invention

This invention relates to the structure of plasma display panels.

The present application claims priority from Japanese Application No. 2004-189314, the disclosure of which is incorporated herein by reference.

2. Description of the Related Art

FIG. 1 is a sectional view illustrating the structure of a surface-discharge-type alternating-current plasma display panel (hereinafter referred to as “PDP”).

FIG. 1 is a sectional view of part of the PDP taken along the column direction (the vertical direction of the panel). A plurality of row electrode pairs (X, Y) each extending in the row direction are regularly arranged in the column direction on the back-facing face (the face facing toward the back of the PDP) of the front glass substrate 1 serving as the display surface.

Each of the row electrodes X and Y constituting a row electrode pair (X, Y) is composed of a bus electrode Xa (Ya) extending in a bar shape in the row direction, and transparent electrodes Xb (Yb) regularly spaced along the bus electrode Xa (Ya) and each extending out therefrom toward its counterpart row electrode Y (X) to face the corresponding transparent electrode Yb (Xb) with a discharge gap g in between.

The row electrode pairs (X, Y) are covered by the dielectric layer 2. The back-facing face of the dielectric layer 2 is covered by an MgO protective layer 3.

The back glass substrate 4 facing the glass substrate 1 across a discharge space has a front-facing face (the face facing toward the display surface) on which a plurality of column electrodes D are regularly arranged in the row direction, a column-electrode protective layer 5 covers the column electrodes D and an approximate grid-shaped partition wall unit 6 is formed. Each of the column electrodes D extends in the column direction along a strip opposite the paired transparent electrodes Xb and Yb of the row electrodes X and Y which are formed on the front glass substrate 1. The partition wall unit 6 partitions the discharge space defined between the front glass substrate 1 and the back glass substrate 4 into areas each corresponding to the paired transparent electrodes Xb and Yb facing each other across the discharge gap g to form discharge cells C.

Further, red-, green- and blue-colored phosphor layers 7 are provided in the individual discharge cells C defined by the partition wall unit 6 and lined up in order in the row direction.

The discharge cells C are filled with a discharge gas including xenon (Xe).

A conventional PDP of such a structure is disclosed in Japanese unexamined patent publication 2000-195431.

In a conventional PDP as described above, the transparent electrodes Xb and Yb of the row electrodes X and Y are formed by patterning. Then, the back-facing face of the front glass substrate 1 is coated with a silver paste (or a silver film is affixed to the back-facing face of the front glass substrate 1) in such a manner as to overlie the proximal ends of the transparent electrodes Xb, Yb to form a bus electrode Xa, Ya.

However, when silver is used to form the bus electrodes Xa and Ya on the front glass substrate 1 in this manner, an alkali element included in the glass material essentially constituting the front glass substrate 1 reacts with the silver of the bus electrodes Xa, Ya to cause a phenomenon in which the part of the front glass substrate 1 in contact with the bus electrodes Xa, Ya is changed in color to yellow.

If such a color change occurs on the front glass substrate 1 serving as the display surface of the panel, the problem of loss of display performance in the PDP arises.

### SUMMARY OF THE INVENTION

It is an object of the present invention to solve the problem associated with the conventional PDP as described above.

To attain this object, a plasma display panel according to the present invention has row electrode pairs formed on one of a pair of substrates facing each other across a discharge space, each row electrode pair being constituted of row electrodes each having a metal electrode portion and transparent electrode portions connected to the metal electrode portion and providing for initiation of a discharge in conjunction with the other row electrode paired therewith. In this plasma display panel, the transparent electrode portions are formed on the substrate. Further, metal-electrode separating-off dielectric layers are formed on portions of the same substrate, and the metal electrode portion is formed on the metal-electrode separating-off dielectric layer and connected to the transparent electrode portions.

In the best mode for carrying out the present invention, a PDP has row electrode pairs formed on the back-facing face of a front glass substrate. Each of the row electrode pairs is constituted of row electrodes each composed of transparent electrodes that are formed on the back-facing face of the front glass substrate and causing a sustaining discharge in conjunction with its counterpart row electrode, and a silver-made bus electrode that is connected to the transparent electrodes. The bus electrode is formed on a bus-electrode separating-off dielectric layer that is formed on a strip portion of the front glass substrate extending along one ends of the transparent electrodes which are located apart from the other row electrode paired therewith. The bus-electrode separating-off dielectric layer is formed of a dielectric material not including an alkali element. Thus, the bus electrode is connected to the transparent electrodes without contact with the front glass substrate.

With the PDP in this best mode, the bus-electrode separating-off dielectric layer formed of the material not including an alkali element separates the silver-made bus electrode and the front glass substrate from each other to prevent direct contact. Accordingly, the reaction between the silver included in the bus electrode and the alkali element included in the front glass substrate does not change the color of the contact portion between the front glass substrate and the bus electrode to yellow, thus overcoming the problem associated with the conventional PDP.

These and other objects and features of the present invention will become more apparent from the following detailed description with reference to the accompanying drawings.

### BRIEF DESCRIPTION OF THE DRAWINGS

FIG. 1 is a sectional view illustrating the structure of a conventional PDP.

FIG. 2 is a sectional view illustrating an embodiment of the present invention.

FIG. 3 is a rear view of a front glass substrate of a PDP in the embodiment.

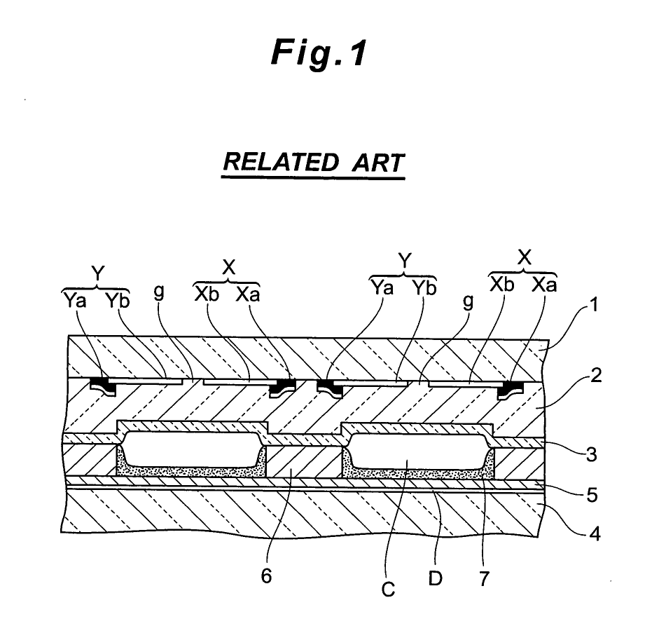

### DETAILED DESCRIPTION OF THE PREFERRED EMBODIMENT

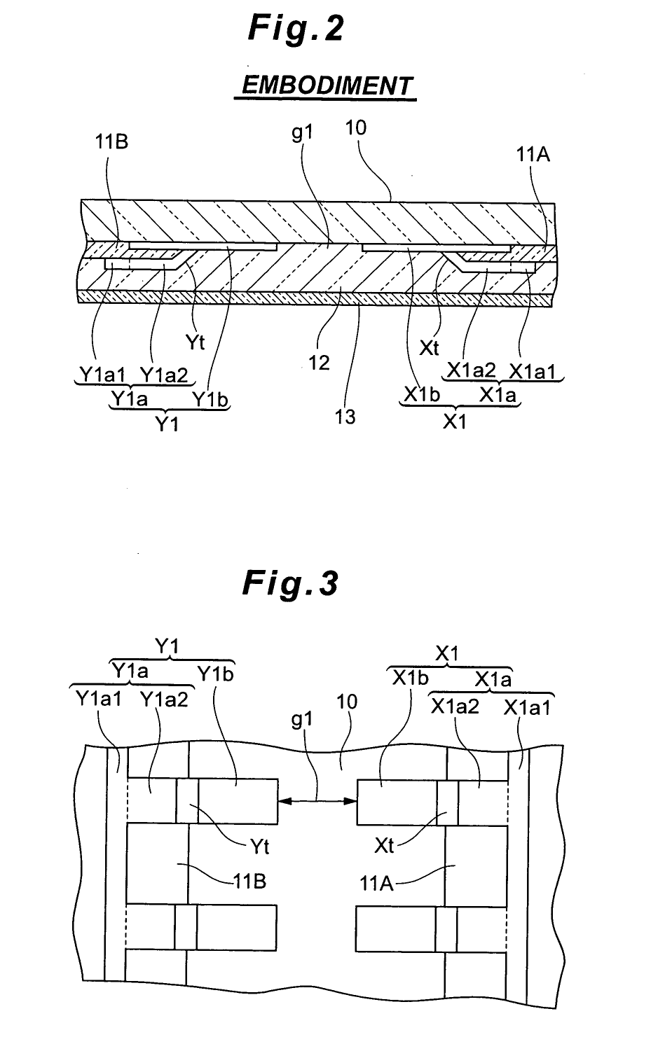

FIGS. 2 and 3 illustrate an embodiment according to the present invention. FIG. 2 is a sectional view illustrating the structure of the front glass substrate of the PDP in the embodiment. FIG. 3 is a diagram of the front glass substrate of the PDP when viewed from its back-facing face.

In FIGS. 2 and 3, a front glass substrate 10 has a back-facing face on which transparent electrodes X1b in the shape of short strip constituting part of each row electrode X1 each extend in a column direction (the right-left direction in FIGS. 2 and 3) and are arranged at regular intervals from each other in a row direction (a direction at right angles to the drawing in FIG. 2 and the vertical direction in FIG. 3).

Further, bus-electrode separating-off dielectric layers 11A are formed in a bar shape on portions of the back-facing face of the front glass substrate 10 in which the proximal-end portions of the transparent electrodes X1b (the right-end portions in FIGS. 2 and 3). Each of the bus-electrode separating-off dielectric layers 11A has a required width in the column direction and extends in the row direction. Each of the bus-electrode separating-off dielectric layers 11A covers the proximal-end portions of the transparent electrodes X1b and a bar-shaped portion of the back-facing face of the front glass substrate 10 including these proximal-end portions.

The bus-electrode separating-off dielectric layer 11A is partially coated with a silver paste (or alternatively a silver film is affix to part of the dielectric layer 11A) to form a bus electrode X1a.

Each of the bus electrodes X1a is composed of an electrode body X1a1 extending in a bar shape in the row direction in a position opposite a portion of the back-facing face of the front glass substrate extending alongside the tops of the proximal ends of the transparent electrodes X1b, and a projecting electrodes X1a2 each formed integrally with the electrode body X1al to extend out therefrom in a strip opposite a part of the corresponding transparent electrode X1b.

Each of the projecting electrodes X1a2 of the bus electrode X1a has a leading end Xt curving toward the front glass substrate 10 along the side face of the bus-electrode separating-off dielectric layer 11A and connected to an approximately central portion of the corresponding transparent electrode X1b.

Likewise, on the back-facing face of the front glass substrate 10, transparent electrodes Y1b in the shape of short strip constituting part of each row electrode Y1 are spaced at regular intervals from each other in the row direction and each extend in the column direction to face the corresponding transparent electrode X1b of the row electrode X1 across a discharge gap g1.

As in the case of the bus-electrode separating-off dielectric layer 11A, bar-shaped bus-electrode separating-off dielectric layers 11B are each formed on a portion of the back-facing face of the front glass substrate 10 in which the proximal-end portions of the transparent electrodes Y1b (the left-end portions in FIGS. 2 and 3) are formed. Each of the bus-electrode separating-off dielectric layers 11B has a required width in the column direction and extends in the row direction. Each of the bus-electrode separating-off dielectric layers 11B covers the proximal-end portions of the transparent electrodes Y1b and a bar-shaped portion of the back-facing face of the front glass substrate 10 including these proximal-end portions of the transparent electrodes Y1b.

The bus-electrode separating-off dielectric layer 11B is partially coated with a silver paste (or alternatively a silver film is affixed to a part of the dielectric layer 11B) to form a bus electrode Y1a.

As in the case of the bus electrode X1a, each of the bus electrodes Y1a is composed of an electrode body Y1a1 extending in a bar shape in the row direction in a position opposite a portion of the back-facing face of the front glass substrate extending alongside the tops of the proximal ends of the transparent electrodes Y1b, and a projecting electrodes Y1a2 each formed integrally with the electrode body Y1a1 to extend out therefrom to oppose the corresponding transparent electrode Y1b.

Each of the projecting electrodes Y1a2 of the bus electrode Y1a has a leading end Yt curving toward the front glass substrate 10 along the side face of the bus-electrode separating-off dielectric layer 11B and connected to an approximately central portion of the corresponding transparent electrode Y1b.

In this manner, the row electrodes X1 and Y1 having the transparent electrodes X1b and Y1b confronting each other across the discharge gaps g1 are paired to constitute a row electrode pair (X1, Y1). The row electrode pairs (X1, Y1) are regularly arranged in plurality in the column direction (FIGS. 2 and 3 show only one of them).

A dielectric layer 12 is further formed on the back-facing face of the front glass substrate 10 and covers the row electrode pairs (X1, Y1).

An MgO protective layer 13 is formed on the back-facing face of the dielectric layer 12.

The bus-electrode separating-off dielectric layers 11A and 11B are formed of a dielectric material such as silica glass which does not include an alkali element by the method of vapor deposition, spattering or the like.

Further, the bus-electrode separating-off dielectric layers 11A and 11B are formed of the same material as the dielectric material not including an alkali element which forms the dielectric layer 12, or of a dielectric material with a lower dielectric constant than that of the dielectric material forming the dielectric layer 12.

With the structure of the foregoing PDP, the bus-electrode separating-off dielectric layers 11A and 11B formed of a dielectric material not including an alkali element separate the bus electrodes X1a, Y1a made of silver (Ag) and the front glass substrate 10 from each other to prevent direct contact. Thus, the silver (Ag) included in the bus electrodes X1a, Y1a and the alkali element included in the front glass substrate 10 are prevented from reacting with each other to change the color of the contact portion between the front glass substrate 10 and the bus electrodes X1a, Y1a to yellow. This prevention in turn prevents a reduction in the display performance of the PDP caused by the color change of the front glass substrate 10.

In the conventional PDP, in the firing process when a silver paste is used to form the bus electrodes of the row electrodes on the front glass substrate, the silver paste may possibly shrink and remains as a residue on the glass substrate. However, when the bus electrodes X1a and Y1a are formed on the bus-electrode separating-off dielectric layers 11A and 11B as described in the embodiment, there is no possibility of the silver paste remaining as a residue on the dielectric layer.

The terms and description used herein are set forth by way of illustration only and are not meant as limitations. Those skilled in the art will recognize that numerous variations are possible within the spirit and scope of the invention as defined in the following claims.

1. A plasma display panel having row electrode pairs formed on one of a pair of substrates facing each other across a discharge space, each row electrode pair being constituted of row electrodes each having a metal electrode portion and transparent electrode portions connected to the metal electrode portion and providing for initiation of a discharge in conjunction with the other row electrode paired therewith,
the plasma display panel comprising a metal-electrode separating-off dielectric layer formed on a portion of the substrate,
wherein the transparent electrode portions are formed on the same substrate, and
wherein the metal electrode portion is formed on the metal-electrode separating-off dielectric layer and connected to the transparent electrode portions.

2. A plasma display panel according to claim 1, wherein the metal-electrode separating-off dielectric layer is formed of a dielectric material not including an alkali element.

3. A plasma display panel according to claim 2, further comprising a dielectric layer that does not include an alkali element, and is formed on the one substrate and covers the row electrode pairs and the metal-electrode separating-off dielectric layers.

4. A plasma display panel according to claim 3, wherein the metal-electrode separating-off dielectric layer is formed of a dielectric material having a lower relative dielectric constant than that of the dielectric layer covering the metal-electrode separating-off dielectric layer.

5. A plasma display panel according to claim 1, wherein the metal electrode portion is formed of silver.

6. Plasma display panel according to claim 1, wherein the metal electrode portion has an electrode body extending in a row direction on the metal-electrode separating-off dielectric layer, and projecting electrodes formed integrally with the electrode body at required intervals from each other on the metal-electrode separating-off dielectric layer and extending out from the electrode body toward the column direction, and the leading end of each of the projecting electrodes is connected to the transparent electrode portion formed in a position corresponding thereto on the substrate.
